(19) United States
(12) Patent Application Publication
(10) Pub. No.: US 2015/0348137 A1
(43) Pub. Date: Dec. 3, 2015

(54) DYNAMIC ADVERTISEMENT PRICING SYSTEM

(71) Applicant: Linkedln Corporation, Mountain View, CA (US)

(72) Inventors: Donald Ellis Flood, Oakland, CA (US); Russell Monroe Glass, Belmont, CA (US); Christopher Lawrence Mann, Fairfax, CA (US)

(21) Appl. No.: 14/294,992

(22) Filed: Jun. 3, 2014

(51) Int. Cl. G06Q 30/02

(52) U.S. Cl. CPC G06Q 30/0275

(57) ABSTRACT

A business management platform (BMP) for dynamically adjusting advertisement bid prices. The BMP receives an advertisement campaign from a marketer, the advertisement campaign being associated with a plurality of advertisements, and including targeting information for those advertisements, and receives segment membership data from a marketing management platform, segment membership data including a mapping of a user to a corresponding segment. The BMP associates the user with an advertisement, of the plurality of advertisements, using the segment membership data and the targeting information. The BMP determines one or more bid factors using the segment membership data, and determines a bid price for displaying the advertisement to the user using the one or more bid factors. The BMP updates the advertisement campaign with the determined bid price.

### BACKGROUND

1. Field of Disclosure

This disclosure relates to the field of business audience marketing, and specifically to dynamically adjusting bid prices for advertisements based on user actions.

2. Description of the Related Art

Marketers generally have a target audience to which they attempt to market their products via various online channels as part of advertising campaigns. The advertising campaigns include advertisements that are associated with specific bid prices. Generally, these bid prices are fixed. Advertisements are selected to provide to users via, for example, advertising servers that conduct advertisement auctions, and provide the advertisement with the highest bid price to the user. An inefficiency with this process is that the bid price is fixed, whereas the marketer's valuation of displaying an advertisement to the user is dynamic. Accordingly, there may be times when the bid price is significantly higher than the actual value to the marketer for displaying the advertisement to the user.

### SUMMARY

The above and other needs are met by a computer-implemented method, a non-transitory computer-readable storage medium storing executable code, and a system for adjusting bid prices for advertisements based on user actions.

One embodiment of the computer-implemented method for dynamically adjusting advertisement bid prices, comprises associating a unique device identifier with a user device used by a user to interact with a plurality of third party platforms. An advertisement campaign is received from a marketer, the advertisement campaign being associated with a plurality of advertisements, and including targeting information for those advertisements. Segment membership data is received from a marketing management platform, segment membership data including a mapping of a user to a corresponding segment. The user is associated with an advertisement, of the plurality of advertisements, using the segment membership data and the targeting information, and one or more bid factors are determined using the segment membership data. A bid price is determined for displaying the advertisement to the user using the one or more bid factors, and the advertisement campaign is updated with the determined bid price.

One embodiment of a non-transitory computer-readable storage medium storing executable computer program instructions for dynamically adjusting advertisement bid prices, comprises associating a unique device identifier with a user device used by a user to interact with a plurality of third party platforms. An advertisement campaign is received from a marketer, the advertisement campaign being associated with a plurality of advertisements, and including targeting information for those advertisements. Segment membership data is received from a marketing management platform, segment membership data including a mapping of a user to a corresponding segment. The user is associated with an advertisement, of the plurality of advertisements, using the segment membership data and the targeting information, and one or more bid factors are determined using the segment membership data. A bid price is determined for displaying the advertisement to the user using the one or more bid factors, and the advertisement campaign is updated with the determined bid price.

One embodiment of a system dynamically adjusting advertisement bid prices, comprises a processor configured to execute modules, and a memory storing the modules. The modules include an identifier module configured to associate a unique device identifier with a user device used by a user to interact with a plurality of third party platforms. The modules also include an assignment module configured to receive an advertisement campaign from a marketer, the advertisement campaign being associated with a plurality of advertisements, and including targeting information for those advertisements. The assignment module is also configured to receive segment membership data from a marketing management platform, segment membership data including a mapping of a user to a corresponding segment, and associate the user with an advertisement, of the plurality of advertisements, using the segment membership data and the targeting information. The modules also include a bid factor module configured to determine one or more bid factors using the segment membership data, and a pricing module configured to determine a bid price for displaying the advertisement to the user using the one or more bid factors. The modules also include a campaign update module configured to update the advertisement campaign with the determined bid price.

### BRIEF DESCRIPTION OF DRAWINGS

FIG. 1 is a high-level block diagram illustrating an embodiment of an environment for a dynamic advertisement pricing system.

FIG. 2 is an interaction diagram of a method for determining advertisement bid prices based on user interactions according to an embodiment.

FIG. 3 is a high-level block diagram illustrating an example computer for implementing the entities shown in FIG. 1.

FIG. 4 is a high-level block diagram illustrating a detailed view of modules within a business management platform according to one embodiment.

FIG. 5 is a flowchart illustrating a process for adjusting bid prices for advertisements based on user actions according to an embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

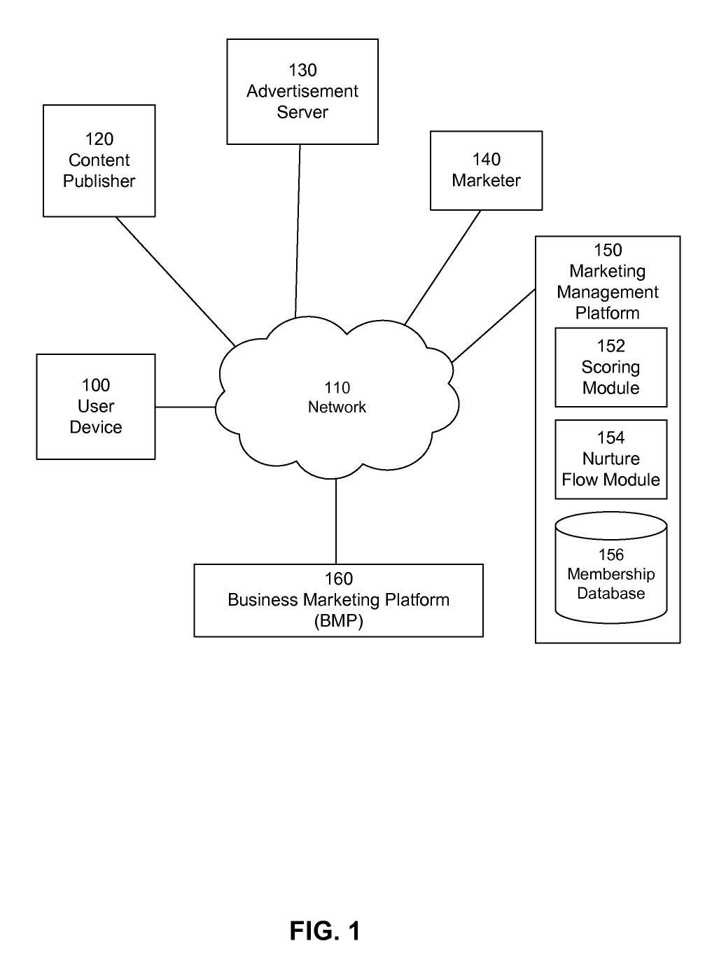

FIG. 1 is a high-level block diagram illustrating an embodiment of an environment of a dynamic advertisement pricing system. The environment includes a user device 100 connected by a network 110 to a content publisher 120, advertisement server 130, marketer 140, marketing management platform 150, and business marketing platform (BMP) 160. Here only one user device 100, content publisher 120, advertisement server 130, marketer 140, marketing management platform 150, and BMP 160 are illustrated but there may be multiple instances of each of these entities. For example, there may be thousands or millions of user devices 100 and marketers 140, in communication with multiple advertisement servers 130, marketing management platforms 150, and BMPs 160. Additionally, in some embodiments, the marketing management platform 150 and the BMP 160 may be the same entity. Similarly, in some embodiments, one or more functions performed by the marketing management platform 150 may be performed by the BMP 160.

The network 110 provides a communication infrastructure between the user devices 100 and the content publisher 120, the advertisement server 130, the marketer 140, the marketing management platform 150, and the BMP 160. The network 110 is typically the Internet, but may be any network, including but not limited to a Local Area Network (LAN), a Metropolitan Area Network (MAN), a Wide Area Network (WAN), a mobile wired or wireless network, a private network, or a virtual private network.

The user devices 100 are computing devices that execute computer program modules—e.g., web browsers or other client applications—which allow a user to access and view content from other systems on the network 110. Additionally, a user device 100 may execute computer program modules that cause the user device to perform one or more operations in-browser. A user device 100 might be, for example, a personal computer, a tablet computer, a smart phone, a laptop computer, or other type of network-capable device such as a networked television or set-top box. In some embodiments, the user device 100 is configured to provide contextual information describing interactions (e.g., purchasing a product) between the user device 100 and the marketer 140 to the marketing management platform 150 and/or the BMP 160.

The user devices 100 request content from the content publisher 120. In some embodiments, the request for content may include request for advertisements. In alternate embodiments, the user devices 100 may request advertisements directly from the ad server 130.

The content publisher 120 provides content to the user devices 100. The content publisher receives a request for content from the user device 100. The content publisher 120 may retrieve the requested content from, e.g., a local data store, some other content provider, etc. The content publisher 120 provides the requested content to the user device 100.

In some embodiments, the request for content may include one or more requests for advertisements. In some embodiments, responsive to receiving a request for one or more advertisements, the content publisher 120 sends a request for advertisements to the advertisement server 130. In some embodiments, responsive to sending a request for advertisements, the content publisher 120 receives advertisements from the advertisement sever 130. The content publisher 120 may provide the advertisements to the user device 100 before, after, or concurrent with providing the requested content to the user device 100. In alternate embodiments, the user device 100 may directly request advertisement from the ad server 130.

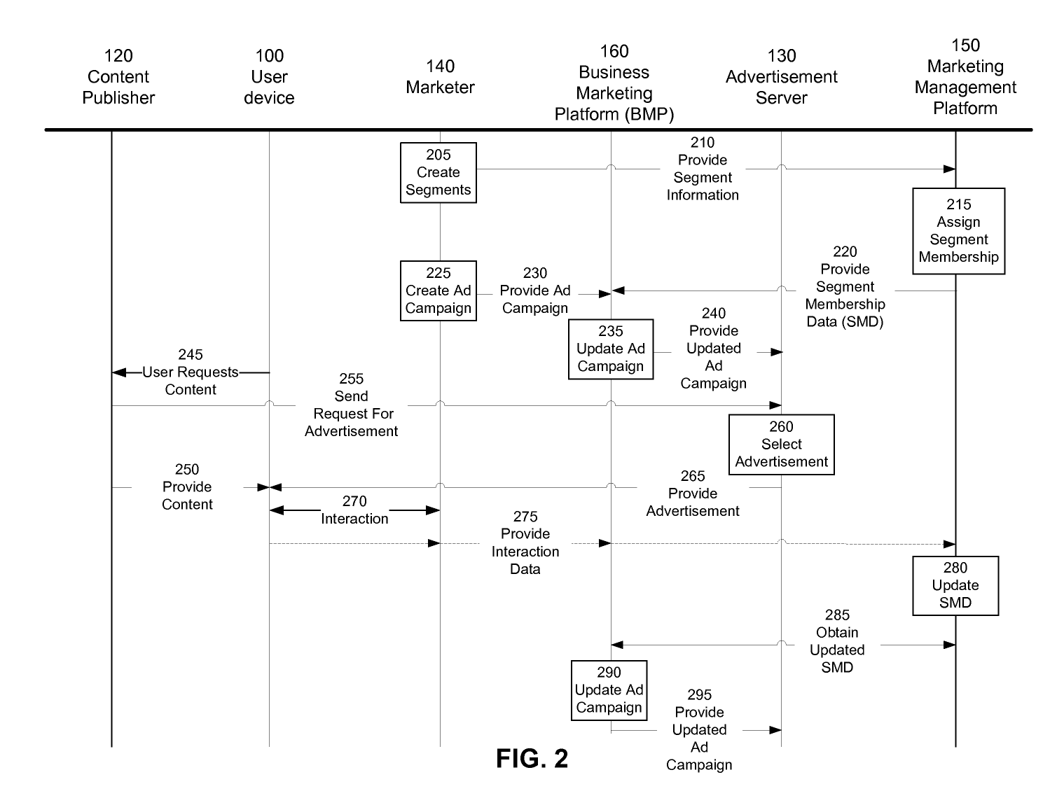

The advertisement server 130 provides advertisements to the user devices 100 and/or the content publisher 120 in accordance with one or more advertising (“ad”) campaigns received from marketers 140. An ad campaign is an advertisement campaign that attempts to persuade users to perform a particular action (e.g., purchase a product/service). An ad campaign includes, for example, one or more advertisements, bid pricing information, targeting information for the advertisements, or some combination thereof. As discussed in detail below, with respect to FIG. 2, responsive to receiving a request for an advertisement, the advertisement sever 130 selects (e.g., via an auction) an advertisement to provide to the user device 100 from a group of candidate advertisements. The advertising server 130 may provide the selected advertisement to the user device 100, the content publisher 120, the marketer 140, or some other entity. In alternate embodiments, the advertising server 130 may select the advertisement from a group of candidate advertisements, and then send a request to some other entity to provide the advertisement to the user device 100.

The marketer 140 includes one or more computer servers that provide content to the user devices 100. The marketer 140 may sell a product and/or service to users of the user devices 100 via, for example, one or more web pages. The marketer 140 has an associated target audience. A target audience is a specific group of people (e.g., users) within a target market to which a marketing message for a product and/or service is aimed. In some embodiments, the marketer 140 is able to receive user information identifying a user visiting its website (e.g., by allowing a visiting user to create an online account, sign up for a newsletter, etc.). User information is information that identifies the user to the marketer 140, and may also describe other attributes of the user. User information may include, for example, a user name, address, email address, telephone number, a user device identifier, interests of the user, etc. In some embodiments, the marketer 140 may send marketing emails to known users. For example, the marketer 140 may send an advertisement for a particular product or service to a user who has signed up for its newsletter.

The marketer 140 creates one or more segments that are associated with a particular nurture flow. A nurture flow is a marketing plan that is divided into progressive segments (e.g., steps) that funnel a user toward performing a particular action (e.g., perform a conversion on a website associated with the marketer 140). Each segment is associated with one or more advertisements that are targeted toward users who are associated with that segment.

Each segment is associated with a measure of influence. A measure of influence is indicative of how likely a user is to perform an intended action (e.g., purchase a product/service). A measure of influence may be, for example, a lead score, a measure of engagement of the user, or some other measure that is indicative of how likely the user is to perform the intended action. For example, each segment may be associated with one or more lead scores that measure the relative probability of a user to become a customer. In general, when a user is first associated with a nurture flow they are associated with an entry segment. An entry segment is associated with users entering the nurture flow. As discussed below with reference to the marketing management platform 150, as the measures of influence of those users increase, they are assigned to progressive levels of segments that funnel the users toward performing a particular action. In some embodiments, the marketer 140 establishes one or more conditions that if satisfied, affect a user's measure of influence. For example, satisfying the conditions may increase the lead score associated with the user. In alternate embodiments, other entities (e.g., the marketing management platform 150, the BMP 160, etc.) may specify one or more of the conditions. The marketer 140 provides segment information describing segments and their associated conditions to the marketing management platform 150. In some embodiments, the marketer 140 may also selectively update one or more segments that were previously provided to the marketing management platform 150.

The marketer 140 creates one or more ad campaigns using the segments. In creating an ad campaign, the marketer 140 may, for example, map groups of advertisements to targeting information, determine bid pricing information for those groups of advertisements, or some combination thereof. Targeting information specifies one or more characteristics of users eligible to be presented with content in the advertisement. Targeting information may be, for example, segments, contextual information, user information, some other information that may be used to select an intended recipient of an advertisement, or some combination thereof. The marketer 140 provides the one or more ad campaigns to the BMP 160. Additionally, in some embodiments, the marketer 140 is configured to provide contextual information describing interactions between the user devices 100 and the marketer 140 to the marketing management platform 150 and/or the BMP 160.

The relative value of the user of the user device 100 to the marketer 140 is likely to change over time. In some embodiments, the marketer 140 attempts to account for the changes in value by using different bid pricing information for advertisements that are associated with different segments. For example, the marketer 140 may attach more value to gaining new customers than repeat customers, and set the bid pricing information associated with segments for new customers higher than bid pricing information associated with segments for repeat customers.

The marketing management platform 150 manages nurture flows associated with an associated marketer 140. The marketing management platform 150 comprises a scoring module 152, a nurture flow module 154, and a membership database 156, in one embodiment. In one embodiment these entities are software application modules executing on the marketing management platform 150. Some embodiments of the marketing management platform 150 have different modules than those described here. Similarly, the functions can be distributed among the modules in a different manner than is described here.

The scoring module 152 determines a measure of influence of a user associated with the user device 100 based in part on whether condition(s) associated with a segment have been satisfied. Additionally, the scoring module 152 updates the measure of influence (e.g., a lead score) for the user device 100 using information (e.g., contextual information) received from the user device 100, the marketer 140, the BMP 160, or some combination thereof.

The nurture flow module 154 maps user devices 100 (and their associated users) to segments within nurture flows based on the measures of influence. Specifically, the nurture flow module 154 maps an identifier (e.g., BMP identifier) associated with the user device 100 and its associated user to a segment. In some embodiments, user devices 100 and their associated users are mapped to an entry segment when they are first associated with a nurture flow. In some embodiments, the nurture flow module 154 may associate a user device 100 and its associated user to some other segment in the nurture flow based on the contextual information received from the marketer 140. The mapping between user devices 100 (and their associated users) and segments is part of segment membership data. Segment membership data includes, for example, one or more segments, one or more identifiers associated with a user device 100 (e.g., a user device identifier and/or a BMP identifier), a mapping of a segment to one or more identifiers associated with a user device 100, or some combination thereof. The nurture flow module 154 passes the segment membership data to the membership database 156.

The nurture flow module 154 updates segment membership data for user devices 100 and their associated users based on changes in their respective measures of influence. For example, an updated measure of influence may cause the nurture flow module 154 to map a user device 100 initially associated with an entry segment to a different segment in the nurture flow. As the measure of influence increases, the user device 100 (and its associated user) may be assigned to segments that progressively funnel the users toward performing one or more actions. For example, the first action may be to join a mailing list of the marketer 140, a second action may be to purchase a product, a third action may be to purchase another product, etc. A user device 100 and its associated user are only mapped to a single segment in a nurture flow at any given time. However, a user device 100 and its associated user may concurrently be mapped to different segments in other nurture flows. The nurture flow module 154 provides segment information to the BMP 160.

The membership database 156 stores conditions associated with one or more segments and segment information associated with one or more user devices 100 and their associated users. Segment information may include, for example, segment membership data, one or more conditions associated with a segment, contextual information describing interactions between the user device 100 and the marketer 140, or some combination thereof.

The BMP 160 updates the ad campaign with the segment membership data, such that groups of advertisements in the ad campaign are mapped to specific users. For example, a first group of advertisements may be mapped to users (via, e.g., BMP identifiers) associated with a first segment, and a different group of advertisements may be mapped to users associated with a different segment.

As mentioned above, interactions between the user and the marketer 140 may change the value the marketer 140 attaches to displaying a particular advertisement to the user. The BMP 160 dynamically sets bid prices for advertisements targeted to users using updates to the segment membership data (e.g., that occur to an interaction between the user and the marketer 140). In some embodiments, the BMP 160 analyzes bid factors extracted from changes in segment membership data to set bid prices. As described in detail below with respect to FIG. 2, bid factors are considerations (e.g., whether the user is an existing customer) that the BMP 160 uses to set bid prices for advertisements. Additionally, in some embodiments, the BMP 160 also uses bid pricing information received from, e.g., the marketer 140, in the determination of bid prices.

The BMP 160 is able to dynamically adjust bid pricing for advertisements using changes in segment membership data. As interactions occur between the user and the marketer 140, the user will be progressively associated with different segments. Additionally, the marketer 140's relative value of the user in viewing an advertisement is likely to change based on which segment the user is associated with and/or what interactions have occurred between the user and the marketer 140. The BMP 160 dynamically adjusts bid pricing and updates the advertising campaigns based on user interactions with the marketer 140 and/or changes in segment membership. Thus, the BMP 160 is able to effectively set, and adjust, bid prices for advertisements such that they are much closer to their actual values to the marketers 140.

Turning now to a discussion of dynamically updating bid prices, FIG. 2 is an interaction diagram of a method for updating bid prices for advertisements based on user actions according to an embodiment. In various embodiments, the method may include different and/or additional steps than those described in conjunction with FIG. 2. Additionally, in some embodiments, the steps may be performed in a different order than described in conjunction with FIG. 2.

The marketer 140 creates 205 segments associated with a particular nurture flow. Each segment in the nurture flow is associated with a particular measure of influence between the user and the nurture flow. Additionally, each created segment is associated with a measure of influence that determines whether a user device 100 and its associated user are mapped to a particular segment. The measures of influence are determined in part, by satisfying conditions associated with each segment. Conditions may include, for example, presenting a web page associated with the marketer 140 to the user via a user device 100, a user interacting with the marketer 140's website, a user interacting with a particular entity, providing, by the particular entity, an advertisement to the user device 100 for presentation to the user, the marketer 140 sending a communication (e.g., email) to the user device 100, a period of time a user device 100 has been associated with a particular segment, a professional title associated with the user, a company that employs the user, a user attending an event (e.g., user attends a tradeshow), a change in customer status, or some combination thereof. The marketer 140 provides 210 segment information to the marketing management platform 150.

The marketing management platform 150 assigns 215 (associates) the user device 100 and its associated user with a segment. Note, it is understood that a user device 100 and/or a user may be associated with a segment. The marketing management platform 150 may assign a user device 100 to an entry segment or some other segment in the nurture flow. For example, a user who viewed a web page associated with the marketer 140 may be associated with an entry segment, and a user who has already purchased a product from the marketer 140 might be assigned to some other segment further along in the nurture flow.

The marketing management platform 150 stores the received segment information in its membership database 156. Additionally, in some embodiments, the marketing management platform 150 may adjust one or more conditions associated with the segments. Additionally, in some embodiments, the marketing management platform 150 may create and/or delete segments from a particular nurture flow.

The marketing management platform 150 provides 220 segment membership data to the BMP 160. For example, the marketing management platform 150 provides mappings of one or more identifiers associated with the user device 100 to a segment. The one or more identifiers provided by the marketing management platform 150 may be, for example, a user device identifier, a marketing management platform identifier, a BMP identifier, or some combination thereof.

The marketer 140 creates 225 an ad campaign using the created segments. In creating the ad campaign, the marketer 140 maps targeting information to particular advertisements, and determines bid pricing information for each of the advertisements. Bid pricing information describes the range of prices the marketer 140 is willing to pay to display an advertisement and/or group of advertisements to the user. Bid pricing information may include, for example, a value indicator, a range of bid prices, an initial bid price, a maximum bid price, a minimum bid price, an average bid price, or some combination thereof. A value indicator describes a value to the marketer 140 of users associated with a particular segment relative to a value to the marketer 140 of users associated with a different segment. Thus, a value indicator may be used to determine which users the marketer 140 values most. The marketer 140 provides 230 the ad campaign to the BMP 160.

The BMP 160 updates 235 the ad campaign using the segment membership data. In updating the ad campaign with the segment membership data, the BMP 160 updates each segment (part of the targeting information) in the ad campaign with identifiers associated with users assigned to that segment.

Additionally, the BMP 160 sets the bid prices for the advertisements in the ad campaign using the bid pricing information and/or the segment membership data. For example, the BMP 160 may determine one or more bid factors from the segment membership data, and set the bid pricing based in part on the bid factors and the bid pricing information as discussed in detail below with respect to step 290. If no bid factors are determined, the BMP 160 may, e.g., set the bid price for advertisements targeted to the user to an initial bid price. The BMP 160 provides 240 the updated ad campaign to the advertisement server 130.

A user requests 245 content via a user device 100 from a content publisher 120. The content publisher 120 retrieves the requested content and provides 250 the requested content to the user device 100. The request for content includes a request for an advertisement and an identifier (e.g., device identifier, BMP identifier, etc.) associated with the requesting user. The content publisher 120 sends 255 a request for an advertisement to the advertisement server 130. In alternate embodiments, the user device 100 send the request for advertisements directly to the ad server 130.

The advertisement server 130 identifies one or more candidate advertisements based on an identifier associated with the user that is extracted from the request for an advertisement. For example, the advertisements server 130 may identify candidate advertisements from ad campaigns whose targeting information includes the identifier associated with the user. The advertisement server 130 conducts an auction to select 260 an advertisement from the one or more candidate advertisements. The winner of the auction is the candidate advertisement with the highest bid price. The advertisement server 130 provides 265 the selected advertisement to the user device 100. In alternate embodiments, the advertisement server 130 provides the selected advertisement to the content publisher 120 which provides the selected advertisement to the user device 100 for presentation to the user.

In step 270 there is an interaction between a user via, e.g., the user device 100, and the marketer 140. For example, the user device 100 may sign up for a newsletter on the marketer 140's web site, the marketer 140 may send an email to the user device 100, etc. Additionally, in some embodiments, the interaction may take place between the user and the marketer 140 via some other mechanism. For example, a user may telephonically purchase a product from the marketer 140.

The marketer 140 and/or user device 100 provides 275 contextual information describing the interaction between the user device 100 and the marketer 140 to the marketing management platform 150. Contextual information is information describes an interaction between the user device 100 and another entity (e.g., the marketer 140). Contextual information may include, e.g., the user calling the marketer 140, the user visiting the marketer 140's website, the user opening an email of the marketer 140, the user signing up for a newsletter of the marketer 140, the user purchasing a product and/or service from the marketer 140, some other interaction between two entities, or some combination thereof. Additionally, in some embodiments, the marketer 140 and/or user device 100 provides 275 the contextual information to the BMP 160.

The marketing management platform 150 updates 280 a portion of the segment membership data associated with the user device 100, based on the contextual information received from the marketer 140 and/or the user device 100. In some embodiments, the marketing management platform 150 uses a measure of influence (e.g., a lead score or range of lead scores) to measure a user's engagement in a particular nurture flow. The marketing management platform 150 may adjust the measure of influence associated with the user based on the contextual information. For example, the marketing management platform 150 may adjust the measure of influence if the contextual information indicates that one or more conditions associated with segments in the nurture flow are satisfied. Additionally, in some embodiments, the amount the measure of influence is adjusted depends on the type of interaction. For example, signing up for a newsletter on the marketer 140's website may be weighted higher than simply visiting the marketer 140's website. If the adjusted measure of influence falls within a range values associated with a different segment, the marketing management platform 150 de-associates the user device 100 from its original segment and associates it with the segment associated with the adjusted measure of influence.

The BMP 160 obtains 285 the updated segment membership data from the marketing management platform 150. The updated segment data includes identification information for the user device 100 (and its associated user) and the updated segment membership data of the user device 100 (and its associated user). In some embodiments, responsive to updating 280 the segment membership data, the marketing management platform 150 provides the updated segment membership data to the BMP 160. Alternatively, the BMP 160 may periodically (e.g., hourly, daily, etc.) query the marketing management platform 150 for any updated segment membership data.

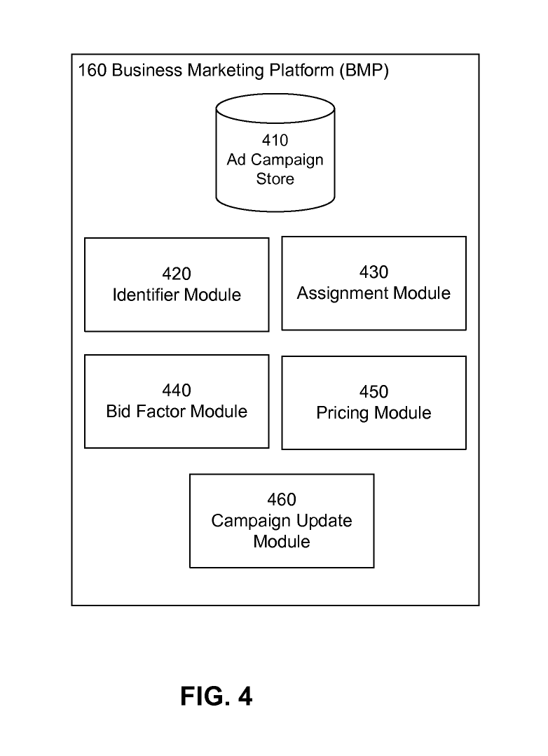

The BMP 160 updates 290 the ad campaign based on one or more bid factors determined from the updated segment membership data and the bid pricing information. The BMP 160 determines the bid factors using the updated segment membership data. Bid factors describe changes in the segment membership data for a user that may influence bid prices associated with advertisements targeted to that user. A bid factor may be, e.g., a change in the measure of influence, a change in the segment membership, a change in customer status, a particular action performed by the user, some other difference between the segment membership data that is received from the marketing management platform 150 and previously stored segment membership data or some combination thereof. As discussed in detail below with respect to FIG. 4, the BMP 160 determines bid price adjustments for advertisements targeted to the user using the bid factors. Additionally, in some embodiments, the BMP 160 may adjust the bid prices based on the bid pricing information. For example, preventing the BMP 160 from adjusting a bid price beyond a maximum bid price. The BMP 160 updates 290 the ad campaign using the adjusted bid prices.

The BMP 160 provides 295 the updated ad campaign to the advertiser server 130. Thus, if the advertisement server 130 receives another request for an advertisement for the user, it would conduct an auction using the updated bid prices. Thus, in this embodiment, the BMP 160 is able to dynamically update bid prices for advertisements based on user interaction with the marketer 140.

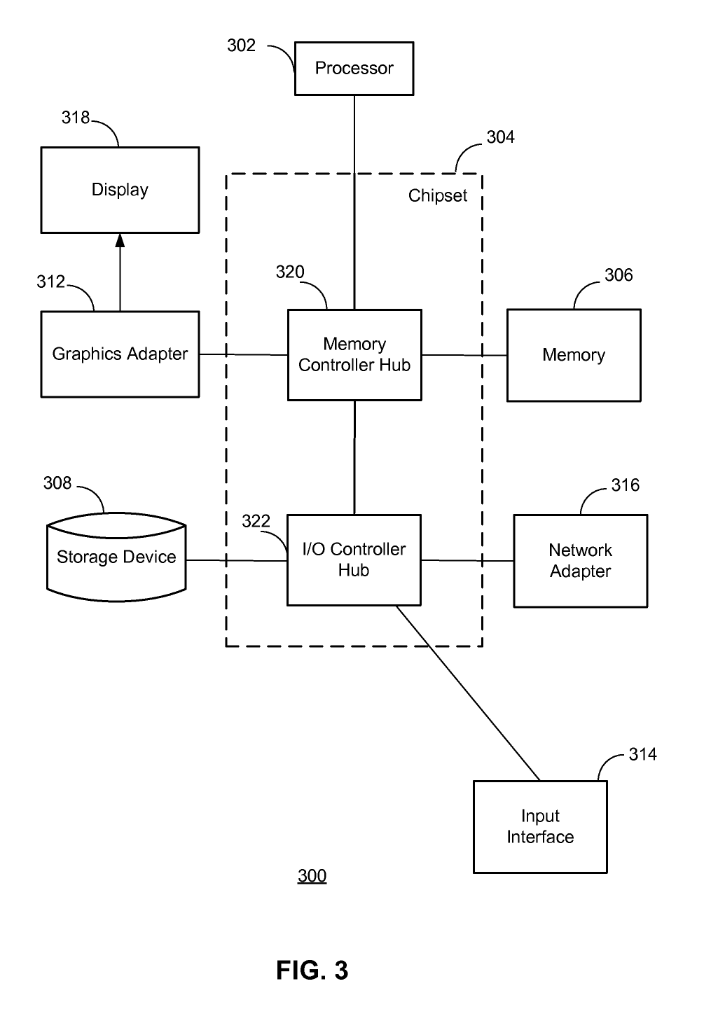

Turning now to a discussion of the implementation of the entities discussed above, FIG. 3 is a high-level block diagram illustrating an example computer 300 for implementing the entities shown in FIG. 1. The computer 300 includes at least one processor 302 coupled to a chipset 304. The chipset 304 includes a memory controller hub 320 and an input/output (I/O) controller hub 322. A memory 306 and a graphics adapter 312 are coupled to the memory controller hub 320, and a display 318 is coupled to the graphics adapter 312. A storage device 308, an input interface 314, and network adapter 316 are coupled to the I/O controller hub 322. Other embodiments of the computer 300 have different architectures.

The storage device 308 is a non-transitory computer-readable storage medium such as a hard drive, compact disk read-only memory (CD-ROM), DVD, or a solid-state memory device. The memory 306 holds instructions and data used by the processor 302. The input device 314 is a mouse, track ball, some other type of pointing device, a keyboard, a graphical user interface, or some combination thereof, used to input data into the computer 300. The graphics adapter 312 displays images and other information on the display 318. The network adapter 316 couples the computer 300 to one or more computer networks.

The computer 300 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 308, loaded into the memory 306, and executed by the processor 302.

The types of computers 300 used by the entities of FIG. 1 can vary depending upon the embodiment and the processing power required by the entity. For example, the user device 100 may interact with one or more servers working together to provide the functionality described herein. The computers 300 can lack some of the components described above, such as keyboards, graphics adapters 312, and displays 318.

FIG. 4 is a high-level block diagram illustrating a detailed view of modules within the BMP 160 according to one embodiment. The BMP 160 is comprised of modules including an ad campaign store 410, an identifier module 420, an assignment module 430, a bid factor module 440, a pricing module 450, and a campaign update module 460. Some embodiments of the BMP 160 have different modules than those described here. Similarly, the functions can be distributed among the modules in a different manner than is described here.

The ad campaign store 410 stores ad campaigns associated with one or more users. In some embodiments, the stored ad campaigns may be associated with different marketers 140. For each ad campaign, the ad campaign store 410 stores associated billing information, and a mapping of groups of advertisements identified by the ad campaign to users associated with segments specified by the targeting information of the ad campaign. Additionally, the ad campaign store 410 stores segment membership data associated with one or more user devices 100. For each user device 100, the ad campaign 410 stores an associated BMP identifier, a mapping of a segment to one or more identifiers associated with the user device 100, or some combination thereof.

The identifier module 420 creates BMP identifiers for user devices 100. A BMP identifier is a value that uniquely identifies a user device 100 to the BMP 160. The identifier module 420 may base the BMP identifier on identifying information received from the user device 100. For example, the BMP identifier may be generated from a hash of information associated with a user device 100, or a hash of portions of user information (e.g., hash of the user's email address) associated with the user device 100. The identifier module 420 may provide the BMP identifiers to, e.g., the user device 100, the marketer 140, the marketing management platform 150, the content publisher 120, the advertisement sever 130, or some combination thereof.

The assignment module 430 associates users with advertisements associated with ad campaigns using segment membership data and targeting information specified by the ad campaigns. The assignment module 430 receives segment membership data from the business marketing platform 150 and/or the ad campaign store 410, and receives ad campaigns from the marketer 140 and/or the ad campaign store 410. The assignment module 430 identifies which segments are associated with which users using the segment membership data (e.g., the segment membership data received from the marketing platform 150). The assignment module 430 determines, for each ad campaign, whether the targeting information specified by the ad campaign includes any of the identified segments. If the targeting information includes the identified segment, the assignment module 430 identifies one or more advertisements specified by the targeting information as being associated with the identified segment. The assignment module 430 then associates the one or more advertisements with users identified as being associated with the identified segment.

The bid factor module 440 determines bid factors using changes in the segment membership data. In some embodiments, to identify bid factors, the bid factor module 440 identifies differences between the segment membership data associated with a user that is received from the marketing management platform 150 and previously stored segment membership data associated with that user. The bid factor module 440 determines one or more bid factors associated with the user, from a set of bid factors, that correspond to the identified differences. The set of bid factors may include, e.g., a change in customer status (e.g., becoming a new customer), a change in the measure of influence, a change in the segment membership, a particular action performed by the user, some other difference between the segment membership data that is received from the marketing management platform 150 and previously stored segment membership data, or some combination thereof.

Each of the bid factors are associated with different weights. In some embodiments, the weights are determined by an administrator of the BMP 160. In alternate embodiments, the bid factor module 440 determines the weights using user information, segment membership data, billing information (e.g., value indicators), or some combination thereof. The bid factor module 440 provides the determined bid factors to the bid pricing module 450.

The pricing module 450 determines bid prices for displaying advertisements to users of the user devices 100 using the determined bid factors. For an advertisement associated with a particular user, the pricing module 450 sums the weights of the bid factors associated with a user to calculate a bid offset. In some embodiments, the bid offset may be negative. The pricing module 450 then applies the bid offset to the bid price associated with the advertisement. The bid offset may be applied to the bid price by, e.g., multiplying the bid price by the bid offset, adding the bid offset by the bid price, some other mathematical operation between the bid price and the bid offset, or some combination thereof.

Additionally, in some embodiments, the determined bid prices are also based on the bid pricing information received from the marketer 140. The pricing module 450 may extract, e.g., a range of bid prices, an initial bid price, a maximum bid price, a minimum bid price, an average bid price, some other information from the bid pricing information, or some combination thereof, from the bid pricing information. The pricing module 450 may then adjust the bid prices of the advertisements based on the extracted information. For example, the pricing module 450 may determine that the bid price exceeds a maximum bid value, and reduce the bid price to the maximum bid value. The pricing module 450 provides the determined bid prices to the campaign update module 460.

The campaign update module 460 updates the ad campaigns with the determined bid prices. Additionally, the campaign update module 460 updates the ad campaigns with portions of the segment membership data. For example, the campaign update module 460 may update the targeting information of an ad campaign with one or more user identifiers, such that the targeting information maps users to specific advertisements and/or groups of advertisements.

The campaign update module 460 provides some, or all of, the updated ad campaigns to the advertisement server 130. For example, if the campaign update module 460 has not previously provided an ad campaign to the advertisement server 130, the campaign update module 460 provides the entire ad campaign. Thereafter, the campaign update module 460 provides the updated portions of the ad campaign. In alternate embodiments, the campaign update module 460 is configured to always provide the entire ad campaign to the advertisement server 130.

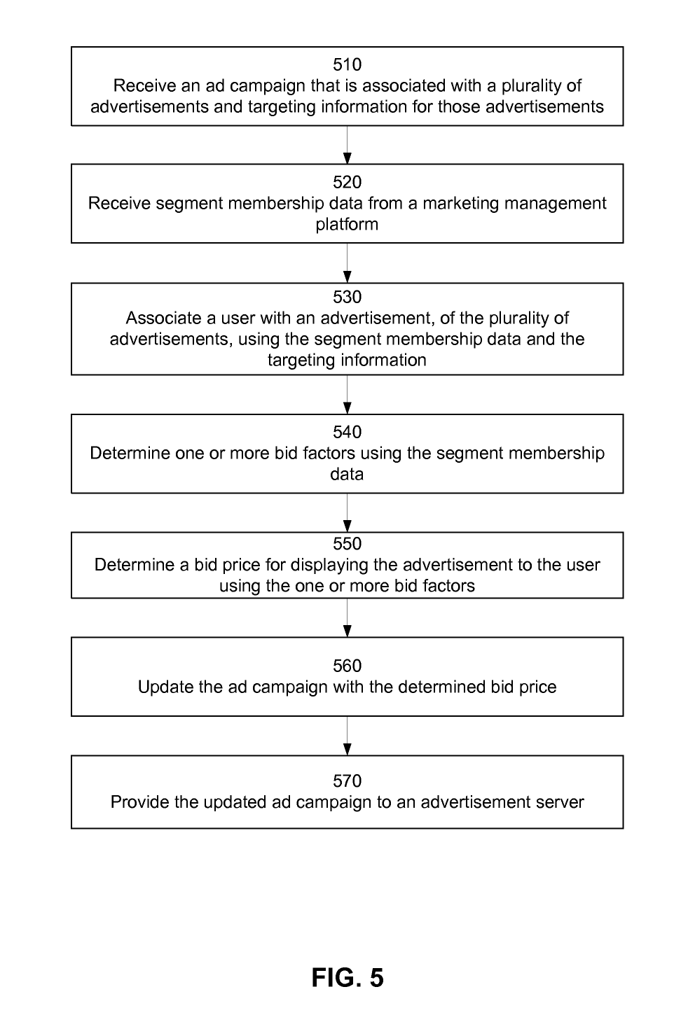

FIG. 5 is a flowchart illustrating a process for adjusting bid prices for advertisements based on user actions according to an embodiment. In one embodiment, the process of FIG. 5 is performed by the BMP 160. Other entities may perform some or all of the steps of the process in other embodiments. Likewise, embodiments may include different and/or additional steps, or perform the steps in different orders.

The BMP 160 receives 510 an ad campaign that is associated with a plurality of advertisements and targeting information for those advertisements. For example, the BMP 160 may receive the ad campaign from a marketer 140.

The BMP 160 receives 520 segment membership data from a marketing management platform 150. The segment membership data specifying which segments are associated with which users.

The BMP 160 associates 530 a user with an advertisement, of the plurality of advertisements, using the segment membership data and the targeting information. For example, the BMP 160 identifies which segment is associated with the user using the segment membership data, determines that the targeting information includes the identified segment, identifies the advertisement associated with the segment, and then associates the advertisement with the user.

The BMP 160 determines 540 one or more bid factors using the segment membership data. For example, to determine bid factors, the BMP 160 identifies differences between the received segment membership data associated with the user and previously stored segment membership data associated with that user. The BMP 160 determines the one or more bid factors, from a set of bid factors, by identifying bid factors that correspond to the identified differences.

The BMP 160 determines 550 a bid price for displaying the advertisement to the user using the one or more bid factors. The BMP 160 sums weights associated with the one or more bid factors to calculate a bid offset. The BMP 160 then applies the bid offset to the bid price associated with the advertisement. Additionally, in some embodiments, the BMP 160 adjusts the determined bid price using bid pricing information received from the marketer 140.

The BMP 160 updates 560 the ad campaign with the determined bid price.

Additionally, in some embodiments, the BMP 160 may update the ad campaign with portions of the segment membership data (e.g., update the targeting information of an ad campaign with one or more user identifiers, such that the targeting information maps users to specific advertisements and/or groups of advertisements). The BMP 160 provides 570 the updated ad campaign to an advertisement server 130.

Some portions of the above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for adjusting bid prices based in part on user actions. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed herein.

1. A computer-implemented method for dynamically adjusting advertisement bid prices, comprising:
receiving an advertisement campaign from a marketer, the advertisement campaign being associated with a plurality of advertisements, and including targeting information for those advertisements;
receiving segment membership data from a marketing management platform, segment membership data including a mapping of a user to a corresponding segment;
associating the user with an advertisement, of the plurality of advertisements, using the segment membership data and the targeting information;
determining one or more bid factors using the segment membership data;
determining a bid price for displaying the advertisement to the user using the one or more bid factors; and
updating the advertisement campaign with the determined bid price.

2. The computer-implemented method of claim 1, wherein determining one or more bid factors using the segment membership data comprises:
identifying differences between the segment membership data received from the marketing management platform and previously stored segment membership data; and
determining bid factors that correspond to the identified differences.

3. The computer-implemented method of claim 2, wherein a bid factor is selected from a group consisting of: a change in the lead score associated with the user, a change in the segment associated with the user, and an interaction that occurred between the user and the marketer.

4. The computer-implemented method of claim 1, wherein determining the bid price for displaying the advertisement to the user using the one or more bid factors, further comprising:
determining weights for each of the one or more bid factors;
summing weights of the one or more bid factors to determine a bid offset; and
adjusting a bid price for the advertisement by applying the bid offset to the bid price.

5. The computer-implemented method of claim 4, further comprising:
receiving bid pricing information from the marketer for one or more advertisements of the advertising campaign; and
adjusting the determined bid price such that it satisfies the bid pricing information.

6. The computer-implemented method of claim 5, wherein adjusting the determined bid price such that it satisfies the bid pricing information, comprises:
determining that the determined bid price is more than the maximum bid price; and
reducing the determined bid price to the maximum bid price.

7. The computer-implemented method of claim 1, further comprising:
providing a portion of the updated advertisement campaign to an ad server;
receiving updated segment membership data from the marketing management platform;
determining one or more new bid factors using the updated segment membership data;
determining a new bid price for displaying the advertisement to the user using the one or more new bid factors;
updating the advertisement campaign with the determined new bid price; and
providing the new bid price to the ad server.

8. A non-transitory computer-readable storage medium storing executable computer program instructions for generating marketing data, the instructions executable to perform steps comprising:
receiving an advertisement campaign from a marketer, the advertisement campaign being associated with a plurality of advertisements, and including targeting information for those advertisements;
receiving segment membership data from a marketing management platform, segment membership data including a mapping of a user to a corresponding segment;
associating the user with an advertisement, of the plurality of advertisements, using the segment membership data and the targeting information;
determining one or more bid factors using the segment membership data;
determining a bid price for displaying the advertisement to the user using the one or more bid factors; and
updating the advertisement campaign with the determined bid price.

9. The computer-readable medium of claim 8, wherein determining one or more bid factors using the segment membership data comprises:
identifying differences between the segment membership data received from the marketing management platform and previously stored segment membership data; and
determining bid factors that correspond to the identified differences.

10. The computer-readable medium of claim 9, wherein a bid factor is selected from a group consisting of: a change in the lead score associated with the user, a change in the segment associated with the user, and an interaction that occurred between the user and the marketer.

11. The computer-readable medium of claim 8, wherein determining the bid price for displaying the advertisement to the user using the one or more bid factors, further comprising:
determining weights for each of the one or more bid factors;
summing weights of the one or more bid factors to determine a bid offset; and
adjusting a bid price for the advertisement by applying the bid offset to the bid price.

12. The computer-readable medium of claim 11, further comprising:
receiving bid pricing information from the marketer for one or more advertisements of the advertising campaign; and
adjusting the determined bid price such that it satisfies the bid pricing information.

13. The computer-readable medium of claim 12, wherein adjusting the determined bid price such that it satisfies the bid pricing information, comprises:
determining that the determined bid price is more than the maximum bid price; and
reducing the determined bid price to the maximum bid price.

14. The computer-readable medium of claim 8, further comprising:
providing a portion of the updated advertisement campaign to an ad server;
receiving updated segment membership data from the marketing management platform;
determining one or more new bid factors using the updated segment membership data;
determining a new bid price for displaying the advertisement to the user using the one or more new bid factors;
updating the advertisement campaign with the determined new bid price; and
providing the new bid price to the ad server.

15. A system for generating marketing data, comprising:
a processor configured to execute modules; and
a memory storing the modules, the modules comprising:
an assignment module configured to:
receive an advertisement campaign from a marketer, the advertisement campaign being associated with a plurality of advertisements, and including targeting information for those advertisements,
receive segment membership data from a marketing management platform, segment membership data including a mapping of a user to a corresponding segment, and
associate the user with an advertisement, of the plurality of advertisements, using the segment membership data and the targeting information; and
a bid factor module configured to determine one or more bid factors using the segment membership data; and
a pricing module configured to determine a bid price for displaying the advertisement to the user using the one or more bid factors; and
a campaign update module configured to update the advertisement campaign with the determined bid price.

16. The system of claim 15, wherein the bid factor module is further configured to:
identify differences between the segment membership data received from the marketing management platform and previously stored segment membership data; and
determine bid factors that correspond to the identified differences.

17. The system of claim 16, wherein a bid factor is selected from a group consisting of: a change in the lead score associated with the user, a change in the segment associated with the user, and an interaction that occurred between the user and the marketer.

18. The system of claim 15, wherein the bid factor module is further configured to:
determine weights for each of the one or more bid factors;
sum weights of the one or more bid factors to determine a bid offset; and
adjust a bid price for the advertisement by applying the bid offset to the bid price.

19. The system of claim 18, wherein the pricing module is further configured to:
receive bid pricing information from the marketer for one or more advertisements of the advertising campaign; and
adjust the determined bid price such that it satisfies the bid pricing information.

20. The system of claim 19, wherein the pricing module is further configured to:
determine that the determined bid price is more than the maximum bid price; and
reduce the determined bid price to the maximum bid price.
